(19) United States
(12) Patent Application Publication
(10) Pub. No.: US 2026/0106061 A1
(43) Pub. Date: Apr. 16, 2026

(54) COIL COMPONENT

(71) Applicant: SAMSUNG ELECTRO-MECHANICS CO., LTD., Suwon-si (KR)

(72) Inventors: Dong Gun LEE, Suwon-si (KR); Joung Hee CHO, Suwon-si (KR); Dong Hwi AHN, Suwon-si (KR)

(73) Assignee: SAMSUNG ELECTRO-MECHANICS CO., LTD., Suwon-si (KR)

(21) Appl. No.: 19/220,876

(22) Filed: May 28, 2025

(30) Foreign Application Priority Data
Oct. 14, 2024 (KR) 10-2024-0139641

(51) Int. Cl. H01F 5/04

(52) U.S. Cl. CPC H01F 5/04

(57) ABSTRACT

A coil component includes a body having a first side surface and a second side surface opposing each other in a first direction, and a third side surface and a fourth side surface opposing each other in a second direction. A coil is disposed within the body, including a lead wire extending to the first and second side surfaces. A lead frame is positioned on the first side surface of the body and is connected to the lead wire. The lead frame includes a side surface portion having an internal surface facing the body and an external surface opposite the internal surface. The lead wire includes a contact portion that is in contact with the internal surface of the side surface portion and a bent portion positioned above the contact portion. The bent portion is positioned closer to the body than the external surface of the side surface portion.

### CROSS-REFERENCE TO RELATED APPLICATION(S)

This application claims the benefit of priority to Korean Patent Application No. 10-2024-0139641 filed on Oct. 14, 2024 in the Korean Intellectual Property Office, the disclosure of which is incorporated herein by reference in its entirety.

### BACKGROUND

### 1. FIELD

The present disclosure relates to a coil component.

### 2. DESCRIPTION OF RELATED ART

An inductor, a coil component, may be a representative passive electronic component in an electronic device along with a resistor and a capacitor.

Recently, the market for power inductors for high current applications such as AI, automotive electronics, and robotics has increased, and in particular, automotive electronic components may require high reliability technology to improve safety, may also satisfy high current properties and may require resistance to vibrations.

### SUMMARY

An aspect of the present disclosure is to provide a coil component which may have improved resistance to vibrations and may address a bonding defect between a lead frame and a coil.

According to an aspect of the present disclosure, a coil component includes a body including a first side surface and a second side surface opposing each other in a first direction, a third side surface and a fourth side surface opposing each other in a second direction, and including a magnetic material; a coil disposed in the body and including a lead wire extending to the first side surface and the second side surface of the body; and a lead frame including a side surface portion disposed on the first side surface of the body and connected to the lead wire, wherein the side surface portion includes an internal surface oriented to the first side surface of the body and an external surface opposing the internal surface, and wherein the lead wire includes a contact portion in contact with an internal surface of the side surface portion and a bent portion disposed in an upper portion of the contact portion, and the bent portion is disposed closer to the body than an external surface of the side surface portion.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a perspective diagram illustrating a coil component according to a first embodiment of the present disclosure;

FIG. 2 is a diagram illustrating a lead frame and a lead wire in FIG. 1;

FIG. 3A is a diagram illustrating a cross-section taken along line II-II′ in FIG. 2;

FIG. 3B is a diagram illustrating a comparative example of FIG. 3A;

FIG. 4 is a diagram illustrating a lead frame in FIG. 1;

FIG. 5 is a diagram illustrating the example in FIG. 1, viewed in a second direction;

FIG. 6 is a cross-sectional diagram taken along line I-I′ in FIG. 1;

FIG. 7 is a diagram illustrating a method of bonding a lead frame and a lead wire according to a first embodiment of the present disclosure;

FIG. 8 is a perspective diagram illustrating a coil component according to a second embodiment of the present disclosure;

FIG. 9 is a diagram illustrating a lead frame and a lead wire in FIG. 8;

FIG. 10 is a diagram illustrating a lead frame in FIG. 8;

FIG. 11 is a cross-sectional diagram taken along line III-III′ in FIG. 8;

FIG. 12 is a perspective diagram illustrating a coil component according to a third embodiment of the present disclosure;

FIG. 13 is a diagram illustrating a lead frame and a lead wire in FIG. 12;

FIG. 14 is a diagram illustrating a lead frame in FIG. 12;

FIG. 15 is a cross-sectional diagram taken along line IV-IV′ in FIG. 12;

FIG. 16 is a perspective diagram illustrating a coil component according to a fourth embodiment of the present disclosure;

FIG. 17 is a perspective diagram illustrating a coil component according to a fifth embodiment of the present disclosure; and

FIG. 18 is a cross-sectional diagram taken along line V-V′ in FIG. 17.

### DETAILED DESCRIPTION

Hereinafter, embodiments of the present disclosure will be described as follows with reference to the attached drawings.

The present disclosure may, however, be exemplified in many different forms and should not be construed as being limited to the specific embodiments determined forth herein. An exhibition used in the singular encompasses the exhibition of the plural, unless it has a clearly different meaning in the context. The terms, “include,” “comprise,” “is configured to,” or the like of the description are used to indicate the presence of features, numbers, steps, operations, elements, portions or combination thereof, and do not exclude the possibilities of combination or addition of one or more features, numbers, steps, operations, elements, portions or combination thereof. Also, the exhibition that an element is disposed “on” may indicate that the element may be disposed above or below a target portion, and does not necessarily indicate the element is disposed above the target portion in the direction of gravity.

It will be understood that when an element is “coupled with/to” or “connected with” another element, the element may be directly coupled with/to another element, and there may be an intervening element between the element and another element. Conversely, it will be understood that when an element is “directly coupled with/to” or “directly connected to” another element, there is no intervening element between the element and another element.

For example, structures, shapes, and sizes described as examples in embodiments in the present disclosure may be implemented in another exemplary embodiment without departing from the spirit and scope of the present disclosure.

In the drawings, the X-direction may be defined as a first direction or a length direction, the Y-direction may be defined as a second direction or a width direction, and the Z-direction may be defined as a third direction or a thickness direction.

In the drawings, the same elements will be indicated by the same reference numerals. Also, redundant descriptions and detailed descriptions of known functions and elements which may unnecessarily render the gist of the present disclosure obscure will not be provided.

Various types of electronic components are used in electronic devices, and various types of coil components may be appropriately used between these electronic components for the purpose of removing noise.

That is, in electronic devices, a coil component may be used as a power inductor, a HF inductor, a general bead, a GHz bead, a common mode filter, or the like.

### First Embodiment

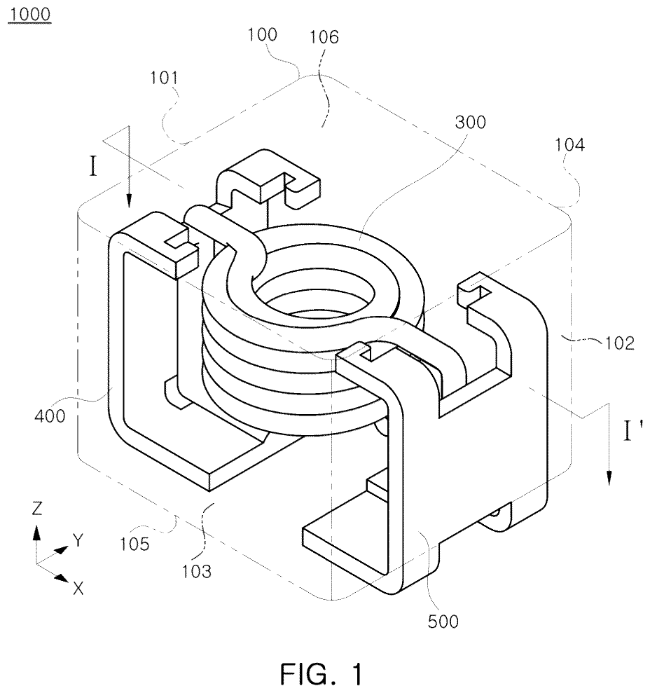

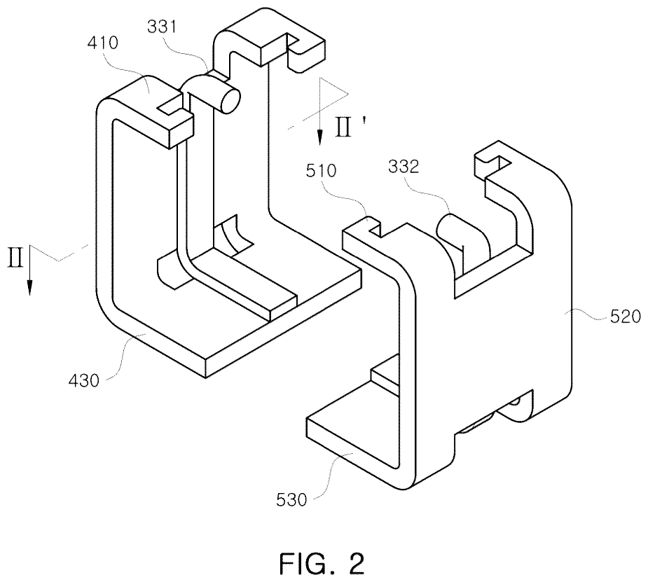

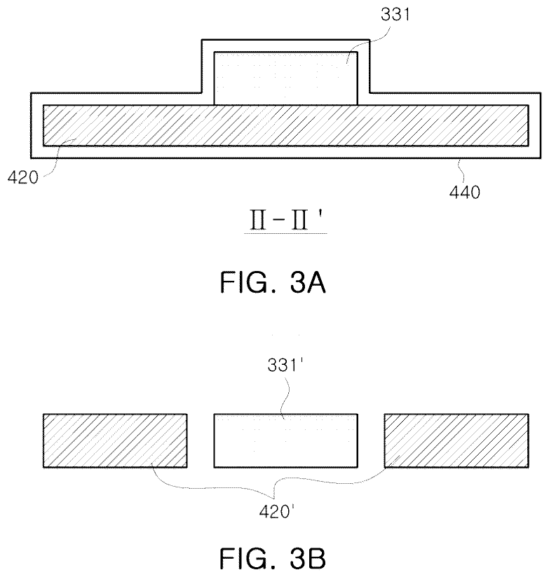

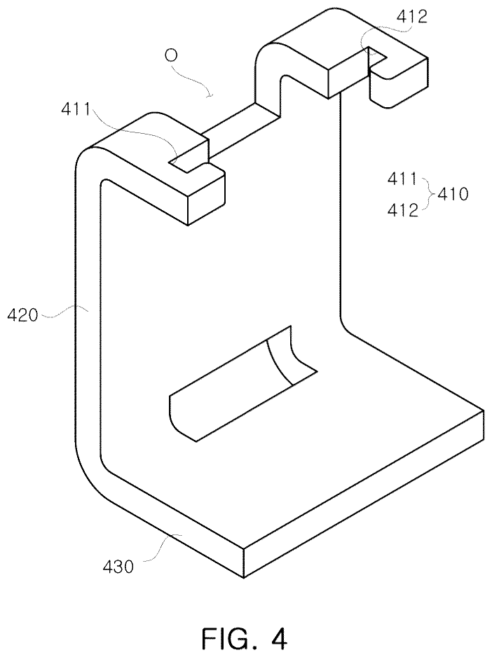

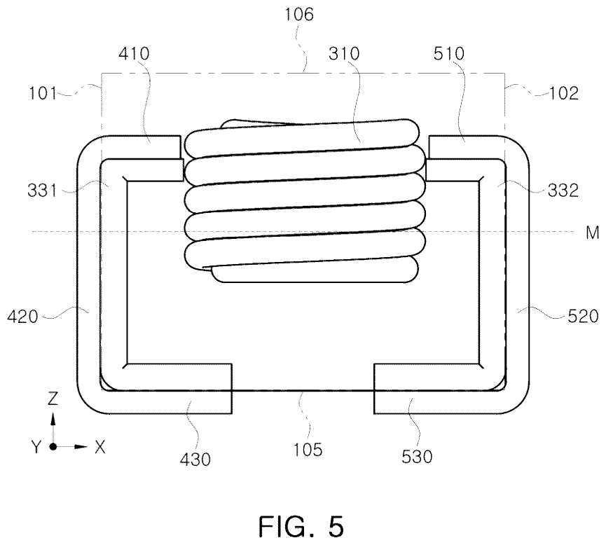

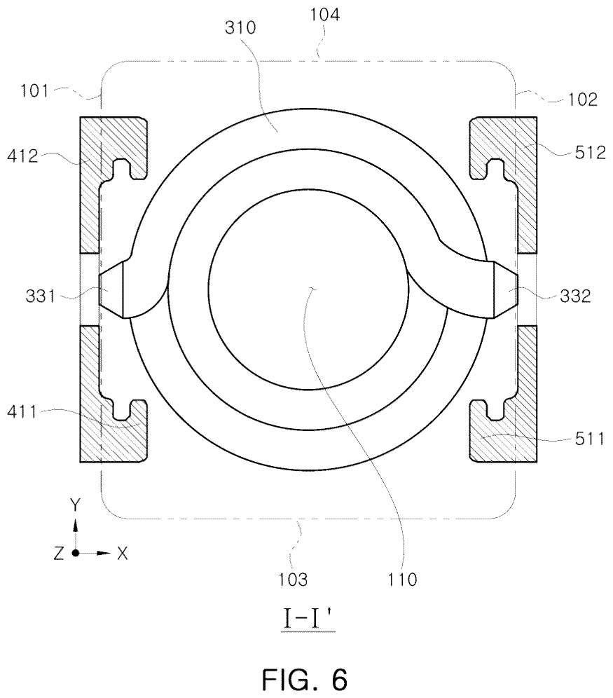

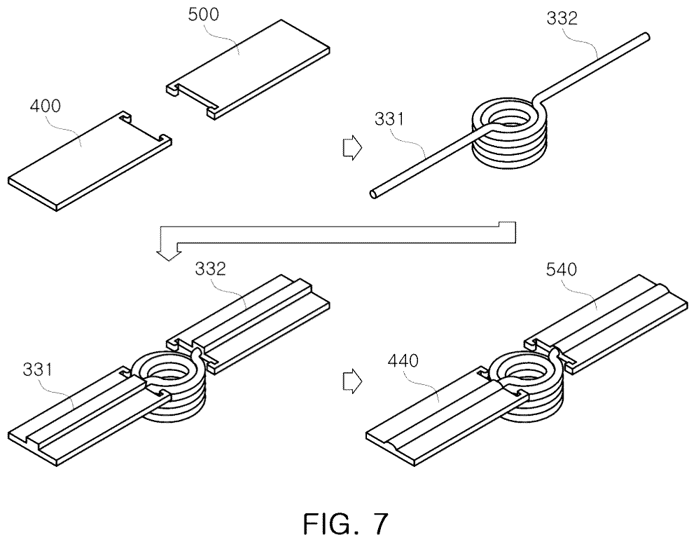

FIG. 1 is a perspective diagram illustrating a coil component according to a first embodiment. FIG. 2 is a diagram illustrating a lead frame and a lead wire in FIG. 1. FIG. 3A is a diagram illustrating a cross-section taken along line II-II′ in FIG. 2. FIG. 4 is a diagram illustrating a lead frame in FIG. 1. FIG. 5 is a diagram illustrating the example in FIG. 1, viewed in a second direction. FIG. 6 is a cross-sectional diagram taken along line I-I′ in FIG. 1. FIG. 7 is a diagram illustrating a method of bonding a lead frame and a lead wire according to a first embodiment.

Referring to FIG. 1, a coil electronic component may include a body 100 including a magnetic material, a coil 300 disposed in the body 100, and lead frames 400 and 500 disposed on a first side surface and a second side surface of the body.

The body 100 may form an overall exterior of the coil component 1000 in the embodiment, and the coil 300 may be embedded therein.

The body 100 may have a hexahedral shape. Referring to FIG. 1, the body 100 may include a first side surface 101 and a second side surface 102 opposing each other in the first direction (X-direction), a third side surface 103 and a fourth side surface 104 opposing each other in the second direction (Y-direction), and a fifth side surface 105 and a sixth side surface 106 opposing each other in the third direction (Z-direction). The first to fourth side surfaces 101, 102, 103, and 104 of the body 100 may be side surfaces of the body 100 connecting the lower surface 105 to the upper surface 106 of body 100.

The body 100 may include a magnetic material. The body 100 may be formed by filling a mold with a magnetic material, and may be formed by filling a composite material including a magnetic material and an insulating resin into the mold. A molding process of applying high temperature and high pressure to the magnetic material or the composite material in the mold may be further performed, but an example embodiment thereof is not limited thereto.

The magnetic material included in the body 100 may be a ferrite or a metallic magnetic powder.

A ferrite powder may be at least one of, for example, spinel-type ferrite such as Mg—Zn-based ferrite, Mn—Zn-based ferrite, Mn—Mg-based ferrite, Cu—Zn-based ferrite, Mg—Mn-Sr-based ferrite, Ni—Zn-based ferrite, hexagonal ferrites such as Ba—Zn-based ferrite, Ba—Mg-based ferrite, Ba—Ni-based ferrite, Ba—Co-based ferrite, Ba—Ni-Co-based ferrite, garnet-type ferrites such as Y-based ferrite, and Li-based ferrites.

The metal magnetic powder may include one or more selected from a group consisting of iron (Fe), silicon (Si), chromium (Cr), cobalt (Co), molybdenum (Mo), aluminum (Al), niobium (Nb), copper (Cu) and nickel (Ni). For example, the magnetic metal powder may be at least one of pure iron powder, Fe—Si alloy powder, Fe—Si—Al alloy powder, Fe—Ni alloy powder, Fe—Ni—Mo alloy powder, Fe—Ni—Mo—Cu alloy powder, Fe—Co alloy powder, Fe—Ni—Co alloy powder, Fe—Cr alloy powder, Fe—Cr—Si alloy powder, Fe—Si—Cu—Nb alloy powder, Fe—Ni—Cr-based alloy powder and Fe—Cr—Al alloy powder.

The metal magnetic powder may be amorphous or crystalline. For example, the magnetic metal powder may be a Fe—Si—B—Cr amorphous alloy powder, but an embodiment thereof is not limited thereto.

Each particle of ferrite and magnetic metal powder may have an average diameter of about 0.1 μm to 30 μm, but an embodiment thereof is not limited thereto.

The body 100 may include two or more types of magnetic materials dispersed in a resin. Here, the different types of magnetic materials may indicate that the magnetic materials dispersed in the resin may be distinguished from each other by one of an average diameter, composition, crystallinity, and shape. For example, the body 100 may include two or more magnetic powders having different average diameters.

The insulating resin may include epoxy, polyimide, a liquid crystal polymer, or the like, alone or in combination, but an embodiment thereof is not limited thereto.

The body 100 may include the core 110. The core 110 may refer to a portion of the body 100 penetrating the coil 300 described below. The core 110 may be disposed in an inner region of the coil 300 forming at least one turn, and the cross-section may have a circular or elliptical shape.

The coil 300 may be disposed in the body 100 and may exhibit characteristics of the coil component. For example, when the coil component 1000 according to the embodiment is used as a power inductor, the coil 300 may store an electric field as a magnetic field and may maintain an output voltage, thereby stabilizing power of the electronic device.

The coil 300 may include a winding portion 310 forming at least one turn with respect to the core 110 and lead-out portions 331 and 332 connected to a winding portion and a lead frame described below.

Referring to FIGS. 1 and 5, the winding portion 310 may form a plurality of turns toward an external side of the body 100 in the first direction (X-direction) and the second direction (Y-direction) of the body 100 from the core 110. The winding portion 310 may be disposed in parallel to the lower surface 105 of the body, and a winding axis of the winding portion 310 may be formed in parallel to the third direction (Z-direction).

The winding portion 310 may be wound in a circular or an elliptical shape, and the core 110 may be disposed in a center.

The first and second lead wires 331 and 332 may be connected to both ends of the winding portion 310, respectively, and may be connected to the lead frames 400 and 500 in the body 100. That is, with respect to FIG. 5, the first lead wire 331 may be connected to the first lead frame 400, and the second lead wire 332 may be connected to the second lead frame 500.

Referring to FIG. 3A, a cross-section of the first lead wire 331 may have a rectangular shape. When the first lead wire 331 is rolled and disposed on the first lead frame 400, the surface of the lead wire and the surface of the lead frame may be bonded to each other. That is, surface bonding may be performed.

At least a portion of the first and second lead wires 331 and 332 may be disposed in the body. Referring to FIG. 5, the first and second lead wires 331 and 332 may be disposed in the body, and may extend to the first side surface 101 and the second side surface 102. The first and second lead wires 331 and 332 may not protrude from the first side surface 101 and the second side surface 102 of the body. To this end, the body 100 may form a groove to accommodate the first and second lead wires 331 and 332.

The first and second lead wires 331 and 332 may include a contact portion in contact with the side surface portions 420 and 520 described below, and a bent portion disposed in the upper portion of the contact portion. Referring to FIG. 2, the lead wire 331 may be bent along the bent portion, and may be in contact with the lead frame in the contact portion. Referring to FIG. 5, the bent portion may not protrude externally of the body even when the bent portion is not in contact with the lead frame.

The coil 300 may be a hollow coil, may be configured as a metal wire MW having a circular cross-section, and may be configured as a flat coil, but an embodiment thereof is not limited thereto.

The coil 300 may be formed by winding a conductive metal, and the portions other than the portions in contact with the lead frames 400 and 500 described below may be coated with an insulating film. Specifically, the coil 300 may be formed by winding a metal wire MW such as a copper wire (Cu-wire) including a metal wire and an insulating film covering the surface of the metal wire into a spiral shape.

Referring to FIG. 5, the first lead wire 331 may be extending in a region at a level higher than a level of a central line M in the third direction (Z-direction) of the upper surface 106 and the lower surface 105. That is, the first lead wire 331 may be a high-center terminal structure in which the terminal is formed to a region at a level higher than a level of the central line.

Referring to FIGS. 1 to 6, the lead frames 400 and 500 may be disposed on the first side surface 101 and the second side surface 102 of the body 100 from the internal region of the body 100, and may work as external electrodes of the coil component according to the embodiment.

The lead frames 400 and 500 may include the first lead frame 400 disposed on the first side surface 101 of the body 100 and the second lead frame 500 disposed on the second side surface 102 of the body 100. The first lead frame 400 may be connected to the first lead wire 331 of the body 100, and the second lead frame 500 may be connected to the second lead wire 332.

The first lead frame 400 will be mainly described, but the same description may be applied to the second lead frame 500, and overlapping detailed descriptions of the second lead frame 500 may not be provided.

The first lead frame 400 may include an anchor portion 410 having at least a portion disposed in the body, a side surface portion 420 disposed at the first side surface 101, and a lower surface portion 430 disposed at the lower surface 105 of the body.

A portion of the anchor portion 410 may be disposed in the body, and may increase bonding strength between the lead frame 400 and the body 100 through an anchoring effect, and may prevent the lead frame 400 from being detached.

The anchor portion 410 may include a first anchor portion 411 and a second anchor portion 412 spaced apart from each other in the second direction. The first and second anchor portions 411 and 412 may be spaced apart from the first lead wire 331. That is, the first and second anchor portions 411 and 412 may be spaced apart from each other with the first lead wire 331 therebetween. Also, the distance at which the first and second anchor portions 411 and 412 are spaced apart from each other in the second direction (Y-direction) may be greater than the width of the first lead wire 331. Here, the width of the first lead wire 331 may indicate the length of the first lead wire 331 in the second direction (Y-direction).

By forming the first and second anchor portions to be spaced apart from each other in the second direction (Y-direction), such that the anchoring effect may be maximized without impinging on the region of the winding portion 310.

The first lead frame 400 may have a structure extending to the first side surface 101 of the body through the anchor portion 410 and may be bent to the lower surface of the body through the side surface portion 420 and the lower surface portion 430.

The side surface portion 420 may be disposed on the first side surface 101 of the body. The side surface portion 420 may include an internal surface facing the first side surface 101 and an external surface opposing the internal surface.

FIG. 3A is a diagram illustrating a cross-section taken along line II-II′ in FIG. 2. The coil component according to the embodiment may have a contact portion of the first lead wire 331 in contact with the internal surface of the first lead frame 400. In this case, the contact portion of the first lead wire 331 may not be exposed to the external surface of the side surface portion 420.

Similarly, the bent portion of the first lead wire 331 may not be exposed to the external surface of the lead frame 400. That is, the bent portion may be disposed closer to the body 100 than the external surface of the side surface portion 420, and the bent portion may not be coplanar with the external surface of the side surface portion 420.

In summary, the first lead wire 331 may not be coplanar with the external surface of the side surface portion 420. Accordingly, stress generated on the substrate mounting surface may not be directly transferred to the lead wire 331, such that a coil component having high resistance to vibration may be implemented.

Referring to FIG. 5, the lead wires 331 and 332 may extend along the internal surface of the lead frame 400 and 500 to the lower surface 105 of the body. In this case, the contact portion of the first lead wire 331 may be surface-bonded with the first lead frame 400, such that the lead wire and lead frame may have a T-beam shape. Accordingly, stress applied to the lead wires 331 and 332 due to vibration may be efficiently distributed, and a coil component having high resistance to vibration may be implemented.

FIG. 3B is a comparative example in which a lead wire 331′ is exposed to an external surface of a side surface portion 420′. When the lead wire 331′ is exposed to the external surface of the side surface portion 420′, stress generated on the substrate mounting surface may be directly transferred to the lead wire 331′, such that vibration may be weakened.

In a general coil component, both ends of the coil and the lead frame may be welded as points or lines in the body, and an open defect may frequently occur due to an alignment error. Also, since stress applied to the bonding points or lines is concentrated, the coil component may be vulnerable to vibration.

According to the embodiment, the lead wire and the lead frame may be bonded to each other on the external surface of the body, and the lead wire and the lead frame may be surface-bonded. Accordingly, the bonding defect of the lead wire and the lead frame may be prevented, and a coil component having high resistance to vibration may be implemented.

Referring to FIG. 4, the side surface portion 420 may include an opening O penetrating the lead frame 400. The opening O may penetrate the lead frame 400 and may connect the internal surface and the external surface of the side surface portion to each other. By forming the opening O, the side surface portion 420 may be smoothly bent from the anchor portion 410 to the side surface 101 of the body.

The bent portion of the first lead wire 331 may not be exposed to the external surface of the body through the opening O. More specifically, the bent portion of the first lead wire 331 may not be disposed in the opening O. Accordingly, the first lead wire 331 may not be coplanar with the lead frame external surface and may be disposed on the inner side of the lead frame.

The lower surface portion 430 may be disposed on the lower surface 105 of the body and may work as an electrode surface connected to the board when being mounted on the substrate. Referring to FIG. 5, the first lead wire 331 may also be in contact with the lower surface portion 430. In this case, similarly to the side surface portion 420 described above, the first lead wire 331 may not be exposed to the external surface of the lower surface portion 430.

The lead frame 400 and 500 may include a metal such as copper (Cu), silver (Ag), palladium (Pd), and nickel (Ni), and the type of the material may not be limited as long as the material is a conductive metal.

The coil component according to the first embodiment may further include metal layers 440 and 540. Referring to FIG. 3A, the metal layer 440 may cover an internal surface, an external surface, and the lead wires 331 and 332 of the side surface portion 420.

The metal layers 440 and 540 may be configured to bond the lead wires 331 and 332 to the lead frame 400 and 500, and may be formed by a process such as dipping or soldering. The metal layers 440 and 540 may include nickel (Ni), tin (Sn), copper (Cu), or the like, and may include multiple layers.

FIG. 7 is a diagram illustrating a method of bonding a lead frame and a lead wire according to a first embodiment.

The lead frames 400 and 500 and the coil 300 may be prepared. In this case, as for the coil, an insulating film formed on the lead wire may be removed to be bonded to the frames 400 and 500. The lead wires 331 and 332 of the coil from which the insulating film has been removed may be rolled, and the lead wire of the rolled coil may have a rectangular cross-section as described above. Also, thicknesses of the rolled lead wires 331 and 332 may be 0.15 mm to 0.2 mm. Thicknesses of the lead frames 400 and 500 may be 0.2 mm or more. The thicknesses of the lead frames 400 and 500 may be greater than the thicknesses of the rolled lead wires 331 and 332, and in this case, the effect of stress reduction may be maximized.

Widths of the rolled lead wire 331 and 332 may be 0.1 mm or more. The widths of the lead frame 400 and 500 may be 2.5 mm or more. Similarly, the widths of the lead frame 400 and 500 may be greater than the widths of the rolled lead wire 331 and 332.

Thereafter, the lead frame 400 and 500 and the lead wire 331 and 332 may be surface-bonded using a process such as dipping or soldering using the metal layers 440 and 540. The bonded lead frame 400 and 500 and the lead wire 331 and 332 may have a T-beam shape.

### Second Embodiment

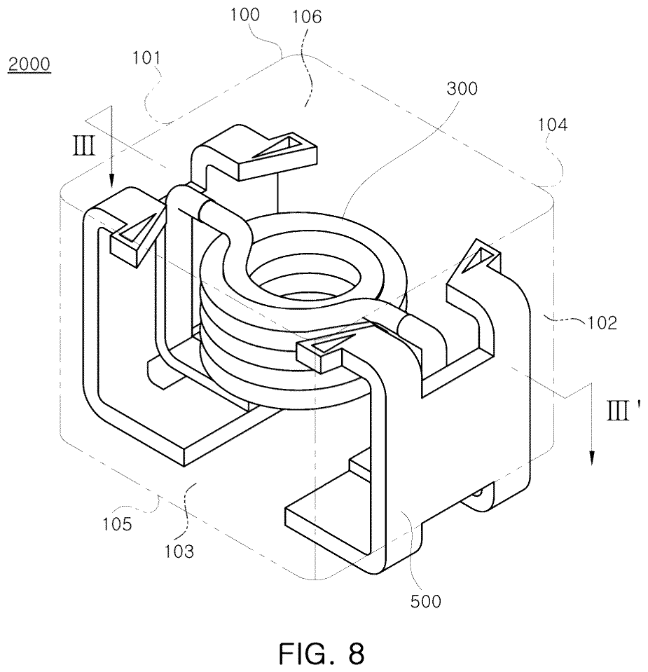

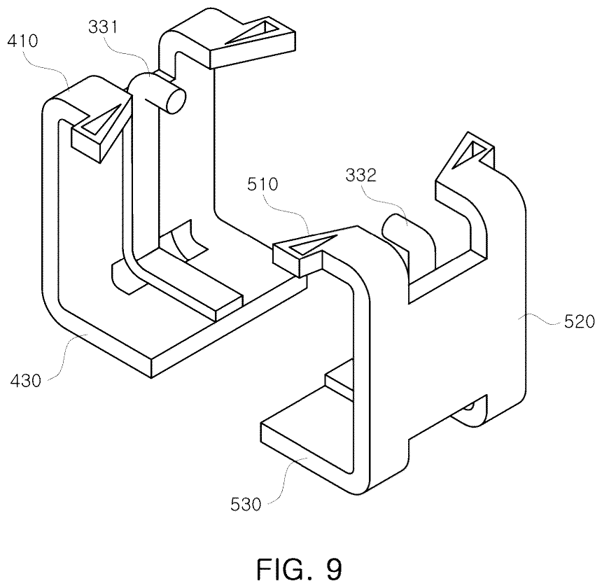

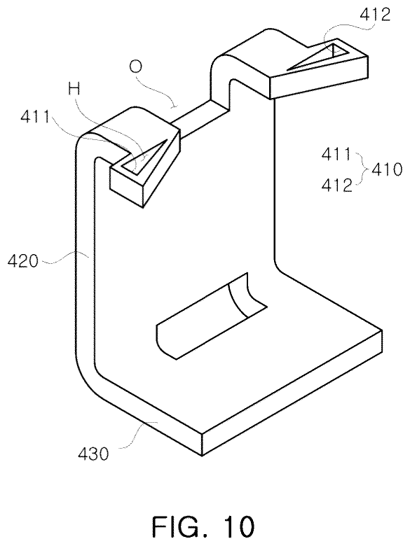

FIG. 8 is a perspective diagram illustrating a coil component according to a second embodiment. FIG. 9 is a diagram illustrating a lead frame and a lead wire in FIG. 8. FIG. 10 is a diagram illustrating a lead frame in FIG. 8.

In the coil component 2000 according to the second embodiment, shapes of anchor portions 410 and 510 may be different from the first embodiment.

Hereinafter, the coil component according to the second embodiment will be described focusing on differences from the first embodiment.

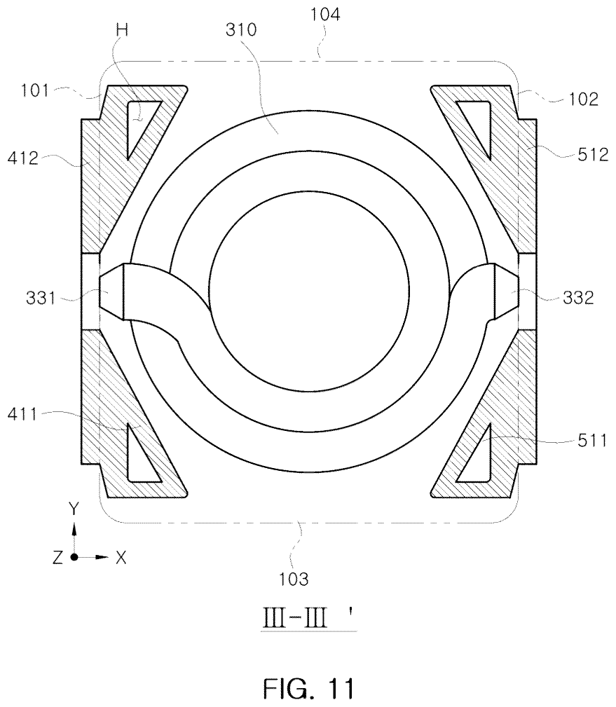

Referring to FIGS. 8 to 11, the anchor portion 410 of the coil component 2000 according to the second embodiment may have a triangular prism shape. Also, the first and second anchor portions 411 and 412 may include a through-hole H penetrating the anchor portion, and a portion of the body 100 may be disposed in the through-hole H. By disposing a portion of the body 100 in the through-hole H, the anchoring effect may be maximized and circulation of the flux may be promoted.

The description of other different components may overlap descriptions of the first embodiment, and overlapping descriptions may not be provided.

### Third Embodiment

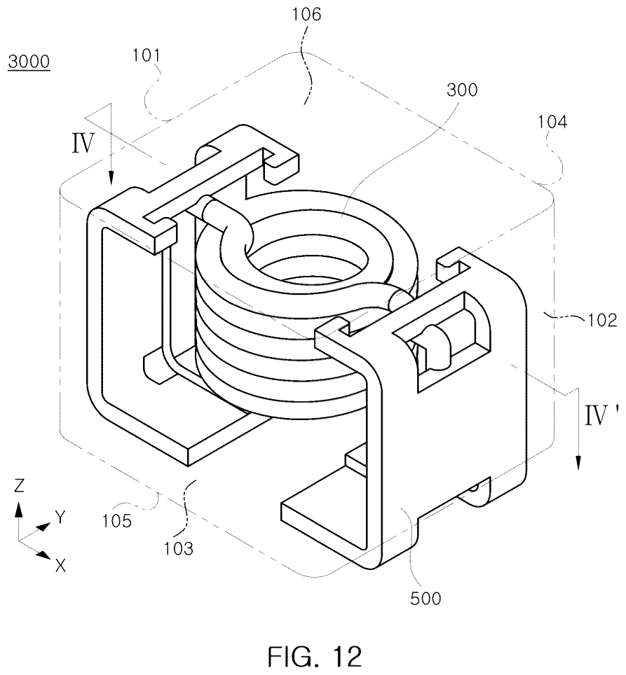

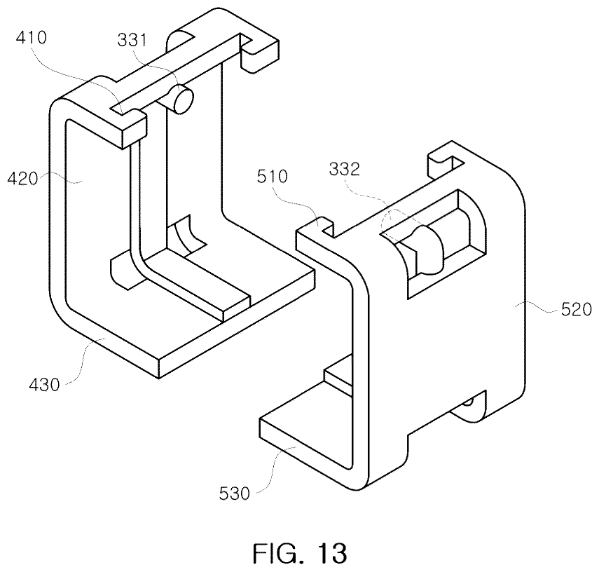

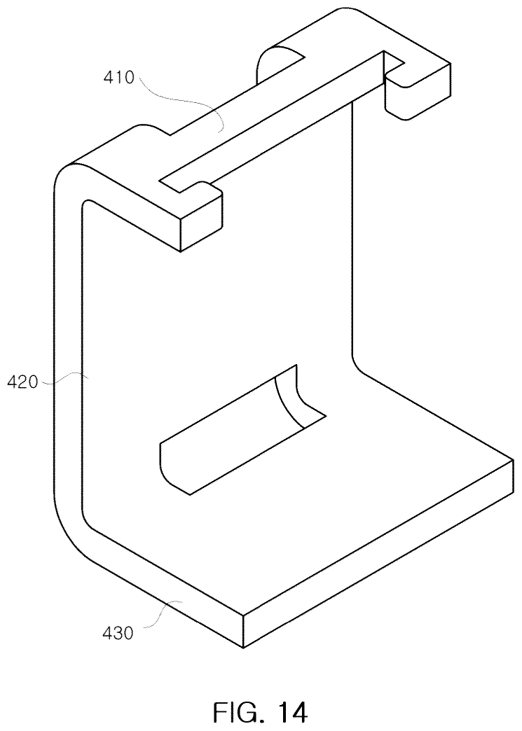

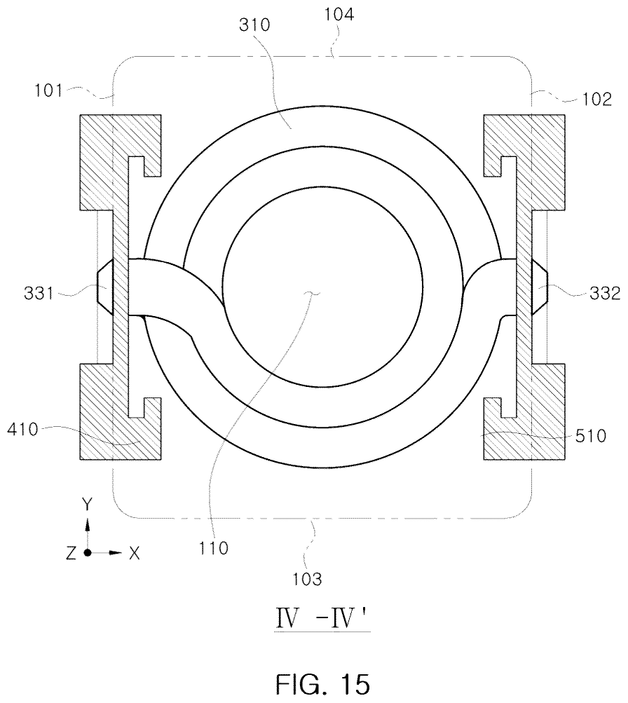

FIG. 12 is a perspective diagram illustrating a coil component according to a third embodiment. FIG. 13 is a diagram illustrating a lead frame and a lead wire in FIG. 12. FIG. 14 is a diagram illustrating a lead frame in FIG. 12. FIG. 15 is a cross-sectional diagram taken along line IV-IV′ in FIG. 12.

In the coil component 3000 according to the third embodiment, shapes of anchor portions 410 and 510 may be different from the first embodiment.

Hereinafter, the coil component according to the third embodiment will be described focusing on differences from the first embodiment.

Referring to FIGS. 12 to 15, the first lead frame 400 of the coil component 3000 according to the third embodiment may have an anchor portion 410. That is, in the case of the coil component 3000 according to the third embodiment, a plurality of anchor portions (first and second anchor portions) in the first embodiment may be connected to each other and an anchor portion may be formed.

The anchor portion 410 may be in contact with the lead wire 331. Specifically, a lead wire 331 may be disposed on a lower surface of the anchor portion 410 (a surface opposing the lower surface of the body), and the lead wire 331 may extend along the lower surface of the anchor portion 410 to the internal surface of the side surface portion 420.

As the lower surface of the anchor portion 410 and the lead wire 331 are in contact with each other, a bonding area between the lead wire and the lead frame may be increased, and an open defect may be improved.

An opening O penetrating the lead frame 400 may be formed between the anchor portion 410 and the side surface portion 420. The lead wire 331 may not be disposed in the opening O, and the lead wire 331 may not be exposed to the external surface of the lead frame 400 through the opening O.

Descriptions of other different components may overlap descriptions of the first embodiment, and overlapping descriptions may not be provided.

### Fourth Embodiment

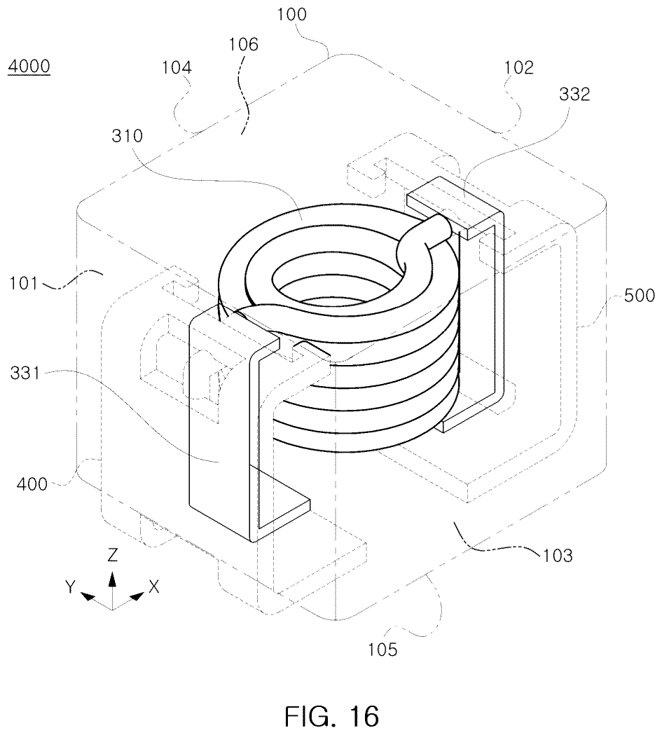

FIG. 16 is a perspective diagram illustrating a coil component according to a fourth embodiment.

In the coil component 4000 according to the fourth embodiment, positions of the lead wires 331 and 332 may be different from the first embodiment.

Referring to FIG. 16, the lead wires 331 and 332 of the coil component 4000 according to the fourth embodiment may be disposed to be shifted to one of the third and fourth side surfaces 103 and 104. Alternatively, the lead wires 331 and 332 may be disposed to be shifted to one of the first and second anchor portions 411 and 412. In this way, by adjusting the positions of the lead wires 331 and 332, the number of turns of the winding portion 310 may be controlled, and Rdc may be designed to a desired value.

The descriptions of other different components may overlap descriptions of the first embodiment, and thus, overlapping descriptions may not be provided.

### Fifth Embodiment

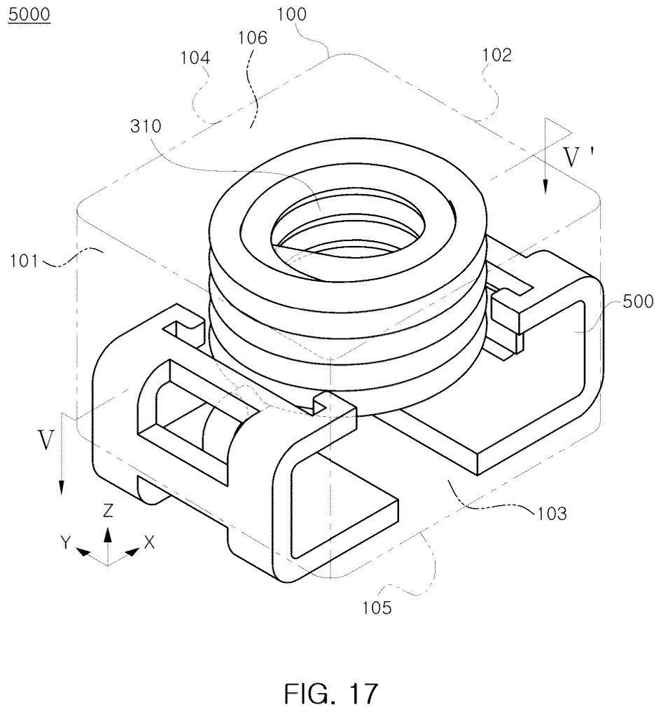

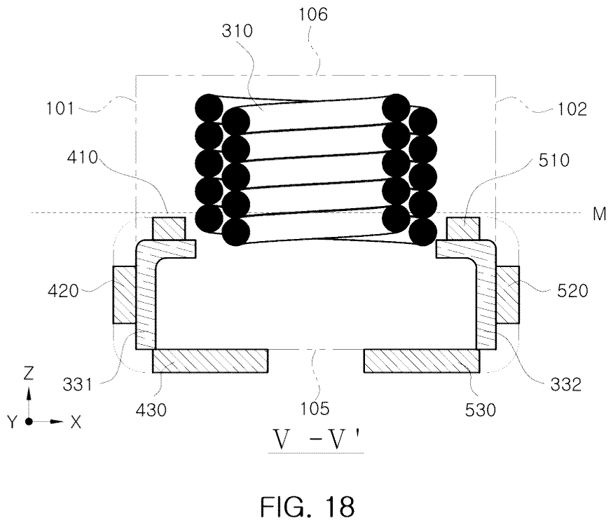

FIG. 17 is a perspective diagram illustrating a coil component according to a fifth embodiment. FIG. 18 is a cross-sectional diagram taken along line V-V′ in FIG. 17.

In the coil component 5000 according to the fifth embodiment, heights of lead wires 331 and 332 may be different from the first embodiment.

Hereinafter, the coil component according to the fifth embodiment may be described focusing on differences from the first embodiment.

The lead wires 331 and 332 of the coil component 5000 according to the fifth embodiment may be extending in a region at a level equal to or lower than a level of the central line M in the third direction of the upper surface 106 and the lower surface 105 of the body. In other words, the terminal may have a low-center terminal structure formed in a region at a level equal to or lower than a level of the central line.

Also, the lead wires 331 and 332 may extend only to the side surface portions 420 and 520, and may not be in contact with the lower surface portions 430 and 530.

Descriptions of other different components may overlap the first embodiment and overlapping descriptions may not be provided.

According to the aforementioned embodiments, a coil component having improved resistance to vibration may be provided.

Also, a coil component which may distribute stress applied to the lead frame may be provided.

Also, a coil component which may improve a bonding defect between the lead frame and the coil may be provided.

While the embodiments have been illustrated and described above, it will be apparent to those skilled in the art that modifications and variations could be made without departing from the scope of the present disclosure as defined by the appended claims.

What is claimed is:

1. A coil component, comprising:
a body including a first side surface and a second side surface opposing each other in a first direction, a third side surface and a fourth side surface opposing each other in a second direction, and including a magnetic material;
a coil disposed in the body and including a lead wire extending to the first side surface and the second side surface of the body; and
a lead frame including a side surface portion disposed on the first side surface of the body and connected to the lead wire,
wherein the side surface portion includes an internal surface oriented to the first side surface of the body and an external surface opposing the internal surface, and
wherein the lead wire includes a contact portion in contact with the internal surface of the side surface portion and a bent portion disposed in an upper portion of the contact portion, and the bent portion is disposed closer to the body than the external surface of the side surface portion.

2. The coil component of claim 1, wherein the bent portion is not coplanar with the external surface of the side surface portion.

3. The coil component of claim 1,
wherein the side surface portion includes an opening penetrating the lead frame, and
wherein the bent portion is not exposed to the external surface of the side surface portion through the opening.

4. The coil component of claim 1, wherein the lead frame further includes first and second anchor portions, at least a part of which is disposed in the body and spaced apart from each other in the second direction.

5. The coil component of claim 4, wherein the first and second anchor portions are spaced apart from the lead wire.

6. The coil component of claim 4, wherein a distance at which the first and second anchor portions are spaced apart from each other in the second direction is greater than a width of the lead wire.

7. The coil component of claim 4,
wherein each of the first and second anchor portions includes a through-hole, and
wherein a portion of the body is disposed in the through-hole.

8. The coil component of claim 1,
wherein the body further includes a lower surface and an upper surface opposing each other in the third direction, connecting the first side surface to the second side surface, and
wherein the coil is wound around an axis extending in the third direction.

9. The coil component of claim 8, wherein the lead frame further includes a lower surface portion, which is connected to the side surface portion and disposed on the lower surface of the body.

10. The coil component of claim 8, wherein the lead wire is extending in a region at a level higher than a level of a central line in the third direction of the upper surface and the lower surface of the body.

11. The coil component of claim 8, wherein the lead wire is extending in a region at a level the same as or lower than a level of a central line in the third direction of the upper surface and the lower surface of the body.

12. The coil component of claim 4, wherein the lead wire is disposed close to one of the first or second anchor portions.

13. The coil component of claim 1, further comprising:
a metal layer covering the internal surface and the external surface of the side surface portion and the lead wire.

14. The coil component of claim 1,
wherein the lead frame further includes an anchor portion at least a part of which is disposed in the body and is contact with the lead wire, and
wherein the anchor portion is in contact with the lead wire.

15. The coil component of claim 1, wherein a thickness of the lead frame is 0.2 mm or more.

16. The coil component of claim 1, wherein a thickness of the lead wire is 0.15 mm or more.

17. The coil component of claim 1, wherein the lead wire and the lead frame contact each other with surfaces thereof defining a T-shaped terminal structure.

18. The coil component of claim 17, further comprising a tin (Sn) coating layer covering the T-shaped terminal structure.
